(19) United States
(12) Patent Application Publication
(10) Pub. No.: US 2026/0034939 A1
(43) Pub. Date: Feb. 5, 2026

(54) CAMERA WING POSITION DETECTION BASED ON IMAGE ANALYSIS

(71) Applicant: Stoneridge Electronics AB, Solna (SE)

(72) Inventors: Song Wang, Novi, MI (US); Utkarsh Sharma, Farmington Hills, MI (US); Liang Ma, Rochester, MI (US)

(21) Appl. No.: 19/286,577

(22) Filed: Jul. 31, 2025

Related U.S. Application Data
(60) Provisional application No. 63/677,544, filed on Jul. 31, 2024.

(51) Int. Cl. B60R 1/28; G03B 17/56

(52) U.S. Cl. CPC B60R 1/28; G03B 17/561; B60R 2300/101; B60R 2300/30

(57) ABSTRACT

A method for a camera monitor system (CMS) includes determining whether a wing has reached a target position. The wing is mounted to a vehicle, supports a camera, and is rotatable between an initial position and the target position. The determining is based on a plurality of images recorded by the camera in conjunction with the wing rotating from the initial position towards the target position. A camera monitor system (CMS) and a method for a camera monitor system (CMS) are also disclosed.

### CROSS-REFERENCE TO RELATED APPLICATION

This application claims the benefit of U.S. Provisional Application No. 63/677,544, filed on Jul. 31, 2024, the disclosure of which is incorporated herein by reference in its entirety.

### TECHNICAL FIELD

This disclosure relates to a camera monitor system (CMS), and more particularly to methods and systems for determining a camera wing position based on image processing.

### BACKGROUND

Mirror replacement systems, and camera systems for supplementing mirror views, are utilized in commercial vehicles to enhance the ability of a vehicle operator to see a surrounding environment of the commercial vehicle. Camera monitor systems (CMS) utilize one or more cameras to provide an enhanced field of view to a vehicle operator. In some examples, the CMS covers a larger field of view than a conventional mirror, or include views that are not fully obtainable via a conventional mirror.

In a typical CMS, there is a camera arm (or “wing”) arranged on each of the left- and right-hand sides of the tractor to provide Class II and Class IV views. The camera arm typically includes a camera wing and a base. The camera wing is typically mounted to the body of the vehicle via a base. In some known examples, the camera wing is moveably mounted to the base, and in particular is rotatable between a retracted position and an extended position. Within the vehicle, a display is provided on the A-pillars on driver and passenger sides to display the field of view for the camera arm on that side, simulating a conventional mirror.

In some applications, the camera wing may be configured to fold, either manually or in response to actuation of a motor. For some customers, it may be desirable to automatically determine without driver input whether the camera is unfolded and in a position that will continue to provide the desired view, or is properly folded. However, there are instances where the camera wings may not unfold correctly, such as when obstructed by external objects, or due to motor failure.

### SUMMARY

A method for a camera monitor system (CMS) according to an example embodiment of the present disclosure includes determining whether a wing has reached a target position. The wing is mounted to a vehicle, supports a camera, and is rotatable between an initial position and the target position. The determining is based on a plurality of images recorded by the camera in conjunction with the wing rotating from the initial position towards the target position.

In a further embodiment of the foregoing embodiment, the initial position is a retracted position, and the target position is an extended position. The camera is disposed closer to a cabin of a commercial vehicle in the retracted position than in the extended position.

In a further embodiment of any of the foregoing embodiments, the initial position is an extended position, and the target position is a retracted position. The camera is disposed closer to a cabin of a commercial vehicle in the retracted position than in the extended position.

In a further embodiment of any of the foregoing embodiments, the method includes determining a plurality of distances traveled by a plurality of features in the plurality images, comparing a sum of the distances to a predefined threshold, and determining that the wing has reached the target position based on the sum of the distances exceeding a predefined threshold.

In a further embodiment of any of the foregoing embodiments, the determining that the wing has reached the target position is further based on the sum of the distances being within a predefined range which has the predefined threshold as a low end of the predefined range.

In a further embodiment of any of the foregoing embodiments, the determining a plurality of distances includes, for each of the plurality of images other than a first one of the plurality of images, detecting one of the plurality of features in the image and in a preceding one of the plurality of images; and determining a distance value corresponding to a distance traveled by the feature between the image and preceding one of the plurality of images. The sum of the distances is a sum of the distance values.

In a further embodiment of any of the foregoing embodiments, the detecting one of the plurality of features in the image and in the preceding one of the plurality of images includes detecting multiple ones of the plurality of features in the image and the preceding one of the plurality of images. The determining a distance value includes determining an average distance traveled by each of the multiple ones of the plurality of features between the image and the preceding one of the plurality of images.

In a further embodiment of any of the foregoing embodiments, the method includes utilizing a Speeded-Up Robust Features (SURF) algorithm or a Scale-Invariant Feature Transform (SIFT) algorithm to identify the plurality of features.

A camera monitor system (CMS) according to an example embodiment of the present disclosure includes a camera, a camera wing that supports the camera and is rotatable between an initial position and a target position, and processing circuitry operatively connected to memory. The processing circuitry is configured to determine, based on a plurality of images recorded by the camera in conjunction with the wing rotating from the initial position towards the target position, whether the wing has reached the target position.

In a further embodiment of the foregoing embodiment, the initial position is a retracted position, and the target position is an extended position. The camera is disposed closer to a cabin of a commercial vehicle in the retracted position than in the extended position.

In a further embodiment of any of the foregoing embodiments, the initial position is an extended position, and the target position is a retracted position. The camera is disposed closer to a cabin of a commercial vehicle in the retracted position than in the extended position.

In a further embodiment of any of the foregoing embodiments, the processing circuitry is configured to determine a plurality of distances traveled by a plurality of features in the plurality images, compare a sum of the distances to a predefined threshold, and determine that the wing has reached the target position based on the sum of the distances exceeding a predefined threshold.

In a further embodiment of any of the foregoing embodiments, the processing circuitry is configured to determine that the wing has reached the target position further based on the sum of the distances being within a predefined range which has the predefined threshold as a low end of the predefined range.

In a further embodiment of any of the foregoing embodiments, to determine the plurality of distances, the processing circuitry is configured to, for each of the plurality of images other than a first one of the plurality of images, detect one of the plurality of features in the image and in a preceding one of the plurality of images, and determine a distance value corresponding to a distance traveled by the feature between the image and preceding one of the plurality of images. The sum of the distances is a sum of the distance values.

In a further embodiment of any of the foregoing embodiments, the processing circuitry is configured to, for each of the plurality of images other than a first one of the plurality of images, detect multiple ones of the plurality of features in the image and the preceding one of the plurality of images, and determine the distance value as an average distance traveled by each of the multiple ones of the plurality of features between the image and the preceding one of the plurality of images.

In a further embodiment of any of the foregoing embodiments, the processing circuitry is configured to utilize a Speeded-Up Robust Features (SURF) algorithm or a Scale-Invariant Feature Transform (SIFT) algorithm to identify the plurality of features.

A method for a camera monitor system (CMS) according to an example embodiment of the present disclosure includes recording a plurality of images from a camera supported by a wing as the wing rotates from an initial position towards a target position, determining a plurality of distances traveled by a plurality of features in the plurality images, comparing a sum of the distances to a predefined threshold, and determining that the wing has reached the target position based on the sum of the distances exceeding a predefined threshold.

In a further embodiment of the foregoing embodiment, the determining that the wing has reached the target position is further based on the sum of the distances being within a predefined range which has the predefined threshold as a low end of the predefined range.

In a further embodiment of any of the foregoing embodiments, the initial position is a retracted position, and the target position is an extended position. The camera is disposed closer to a cabin of a commercial vehicle in the retracted position than in the extended position.

In a further embodiment of any of the foregoing embodiments, the initial position is an extended position, and the target position is a retracted position. The camera is disposed closer to a cabin of a commercial vehicle in the retracted position than in the extended position.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible

### BRIEF DESCRIPTION OF THE DRAWINGS

The disclosure can be further understood by reference to the following detailed description when considered in connection with the accompanying drawings wherein:

FIG. 1 is a schematic front view of a commercial truck with a camera monitor system (CMS) used to provide at least Class II and Class IV views.

FIG. 2 is a schematic birds-eye view of the commercial truck of FIG. 1 with a CMS providing Class II, Class IV, Class V, and Class VI views.

FIG. 3 is a schematic top view of an example vehicle cabin interior.

FIG. 4 is a perspective view of the vehicle cabin interior of FIG. 3.

FIG. 5A is a schematic view of camera wings of FIG. 2 in an extended position.

FIG. 5B is a schematic view of the camera wings of FIG. 2 in a retracted position.

FIG. 6 depicts two example CMS images and various example features identified the images.

FIG. 7 is a flowchart of an example method for a CMS.

FIG. 8 is an example implementation of a portion of FIG. 7.

### DETAILED DESCRIPTION

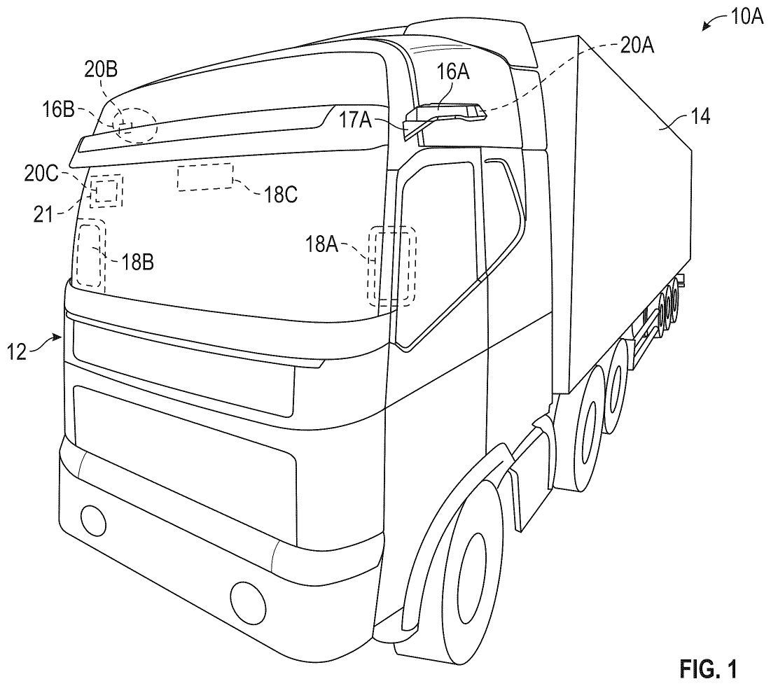

Schematic views of a commercial vehicle 10 are illustrated in FIGS. 1-4. The commercial vehicle 10 includes a vehicle cab or “tractor” 12 for pulling a trailer 14, where the trailer 14 pivots with respect to the tractor 12 during turns. Although the commercial vehicle 10 is depicted as a commercial truck with a single trailer in this disclosure, it is understood that other commercial vehicle configurations may be used (e.g., different types or quantities of trailers, earthmoving machines, etc.).

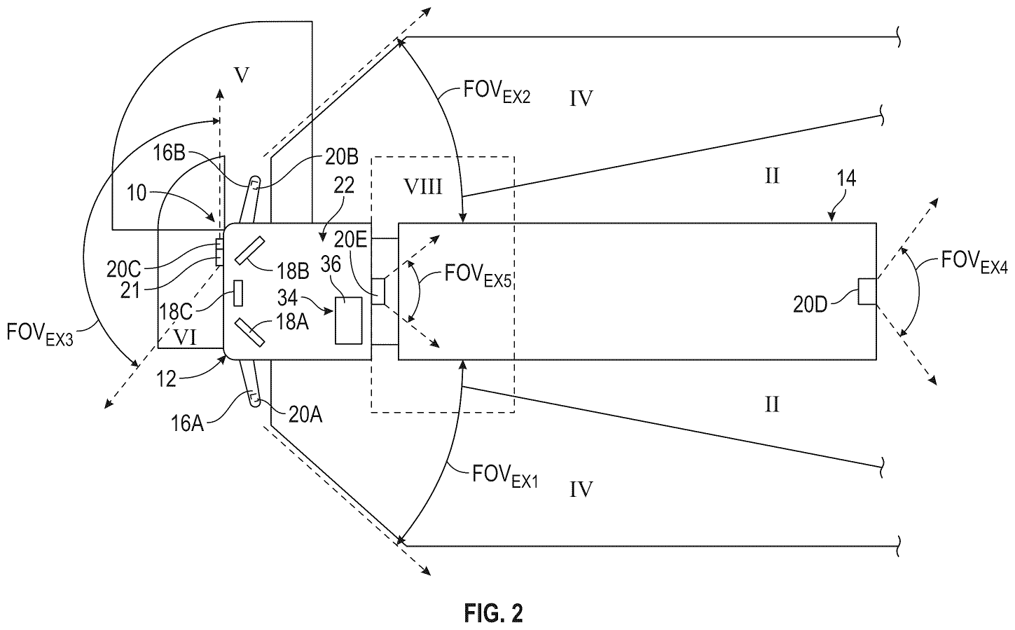

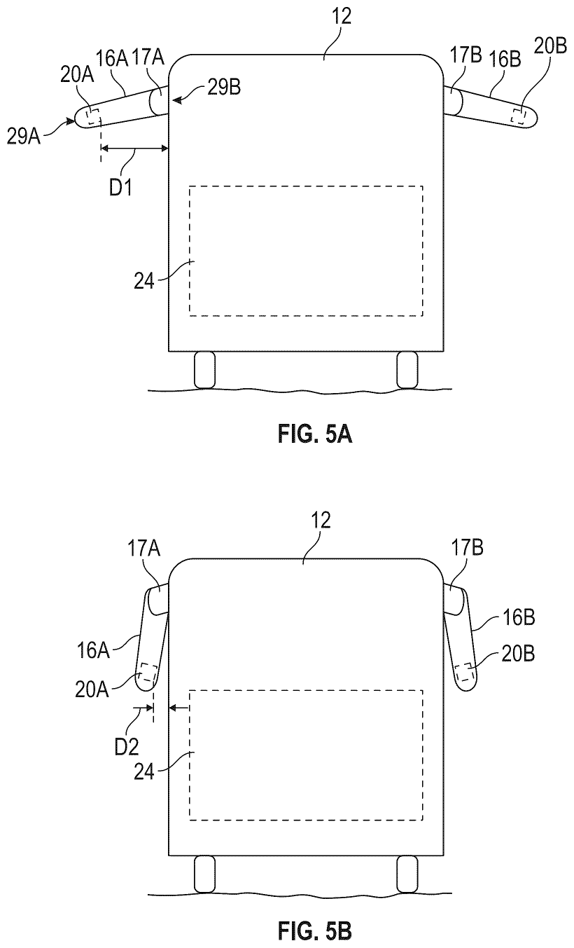

A pair of camera arms or “wings” 16A-B include a respective base 17A-B that is secured to, for example, the tractor 12. The wings 16A-B and bases 17A-B are also shown in FIGS. 5A-B. The respective wings 16A-B are supported by the respective bases 17A-B and articulate relative thereto. At least one rearward facing camera 20A-B is arranged respectively on or within the wings 16A-B. The exterior cameras 20A-B respectively provide an exterior field of view FOV_{EX1}, FOV_{EX2} that each include at least one of Class II and Class IV views (FIG. 2), which are legally prescribed views in the commercial trucking industry.

The Class II view on a given side of the commercial vehicle 10 is a subset of the class IV view of the same side of the commercial vehicle 10. Multiple cameras also may be used in each camera wing 16A-B to provide these views, if desired. Class II (narrow) and Class IV (wide angle) views are defined in European R46 legislation, for example, and the United States and other countries have similar drive visibility requirements for commercial trucks. Any reference to a “Class” view is not intended to be limiting, but is intended as an example of the type of view provided to a display from a particular camera.

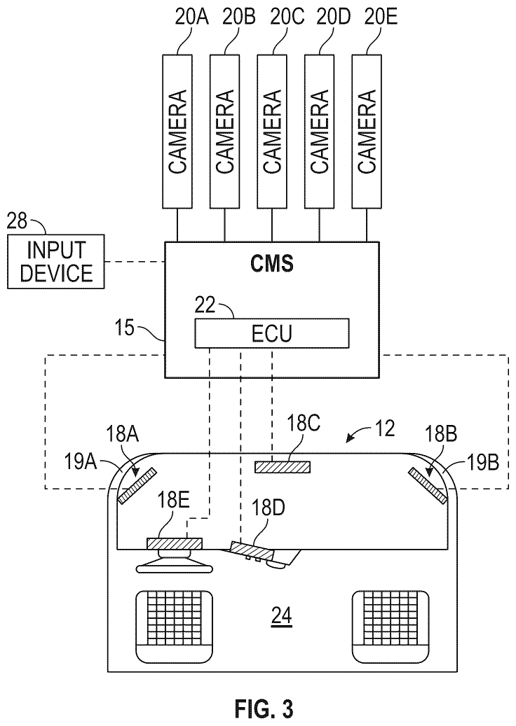

Each wing 16A-B may also provide a housing that encloses electronics, e.g., a controller, that are configured to provide various features of a camera monitor system (CMS) 15 (see FIG. 3). The wings 16A-B may be mounted either at a roof-mount location over the cab door (as shown), or on a door-mounted bracket or station, for example.

A camera housing 21 and camera 20C are arranged near the front of the commercial vehicle 10 to provide an at least partial Class V view and possible also Class VI view (FIG. 2). Alternatively, the camera 20C may be on or within the wing 16B. The camera 20C has a wide angle lens (focal length less than 35 mm), and possibly a “fisheye” lens (focal length on the order of 8-10 mm, for example), and has an associated field of view FOV_{EX3}.

A backup camera 20D may be provided which provides a field of view FOV_{EX4}. The backup camera 20D may be mounted at a top/centerline of the trailer 14, at a bumper/bed level of the trailer 14, or at a top-corner of the back of the trailer 14, for example. Alternatively, or in addition to the rear trailer camera, a “fifth wheel camera” 20E may be provided that is mounted to a rear of the tractor 12 and that provides a field of view FOV_{EX5}. The fifth wheel camera 20E may be mounted anywhere between the lateral plane of the fifth wheel fixture and the top/roof edge of the tractor 12, for example.

Throughout this disclosure, reference numeral 16 will generally be used to refer to a wing that supports a camera 20, and is rotatable between multiple positions.

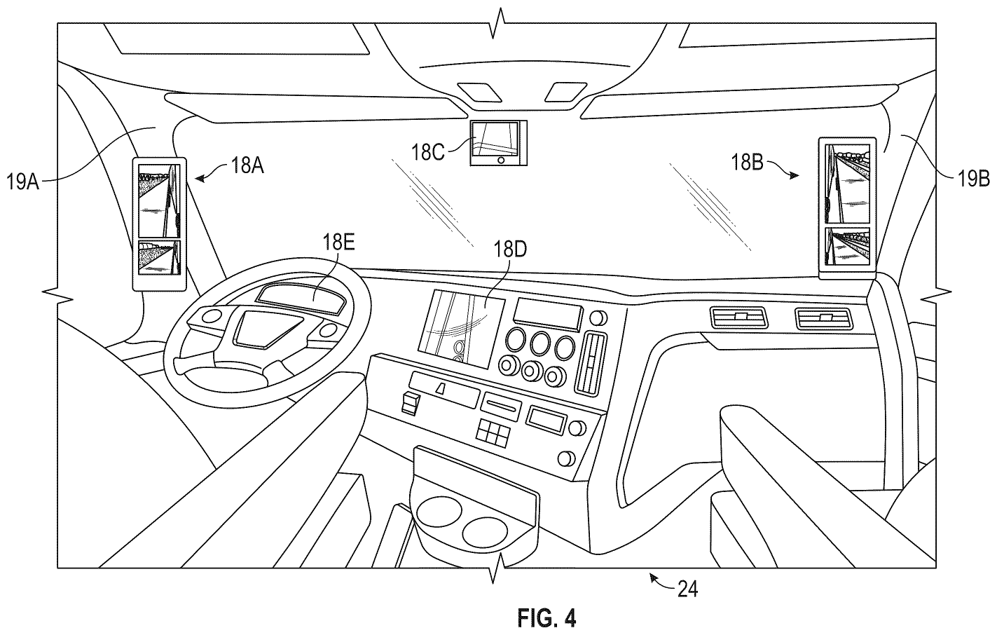

FIG. 3 is a schematic top view of an example vehicle cabin interior 24, and FIG. 4 is a perspective view of the vehicle cabin interior 24. Referring now to FIGS. 3-4 with continued reference to FIGS. 1-2, example locations for electronic displays 18A-E (e.g., which may be video displays, such as LCD displays) and cameras 20A-E are shown. The various electronic displays 18A-E and cameras 20A-E are part of the CMS 15, and therefore act as CMS displays and CMS cameras. As used herein, a “CMS camera” 20 is a camera configured to record images of an environment surrounding a commercial vehicle 10, and a “CMS display” 18 is an electronic display (e.g., an LCD) that is configured to display image feeds from those cameras.

The CMS 15 includes a CMS electronic control unit (ECU) 22 that acts as a controller and includes processing circuitry that supports operation of the CMS 15. The CMS ECU 22 is operatively connected to memory (which may include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). The processing circuitry may include one or more microprocessors, microcontrollers, application specific integrated circuits (ASICs), or the like.

The CMS displays 18A-B are arranged on each of the driver and passenger sides within the vehicle cab 12 on or near the A-pillars 19A-B to display Class II and Class IV views on its respective side of the commercial vehicle 10, which provide rear facing side views along the commercial vehicle 10 that are captured by the exterior cameras 20A-B. An input device 28 (e.g., keyboard, mouse scanner, touch interface, etc.) may be used by a vehicle operator to customize and/or control the CMS 15A.

In the example of FIG. 3, additional displays 18C-E are provided. Display 18C is arranged in the vehicle cabin interior 24 near the top center of the windshield and may be used to display the Class V and Class VI views, for example, which are toward the front of the commercial vehicle 10, or a backup camera view (from camera 20D or 20E) to the driver. Display 18D is provided in a center console area of the vehicle cabin interior 24, and may be used for other purposes, such as navigation, infotainment, etc. Display 18E may be part of an instrument cluster, for example.

If desired, the camera wings 16A-B may include conventional mirrors integrated with them as well, although the CMS 15 may be used to entirely replace mirrors. In additional examples, each side can include multiple camera wings, with each wing housing one or more cameras and/or mirrors.

FIG. 5A is a schematic view of the camera wings 16A-B of FIG. 2 in an example position in which the camera wings 16A-B are fully extended, and each camera is a distance D1 from the tractor 12.

FIG. 5B is a schematic view of the camera wings 16A-B of FIG. 2 in an example position in which the wings 16A-B are fully retracted, and each camera 20A-B is a distance D2 from the tractor. As shown, the cameras 20A-B are disposed closer to cabin 24 and the tractor 12 in the retracted position (i.e., D2<D1) than in the extended position. Also, for each camera wing 16A-B, the camera 20 is disposed In one or more embodiments, the camera wings 16A-B transition to the retracted position of FIG. 5B when the commercial vehicle 10 is turned OFF, and transition to the extended position of FIG. 5A when the commercial vehicle 10 is turned ON. Of course, it is understood that the example wing positions of FIGS. 5A-B are non-limiting examples, and that other wing positions could be used. Also, each camera 20A-B is disposed closer to a distal end 29A of its respective camera wing 16A than to a proximal end 29B.

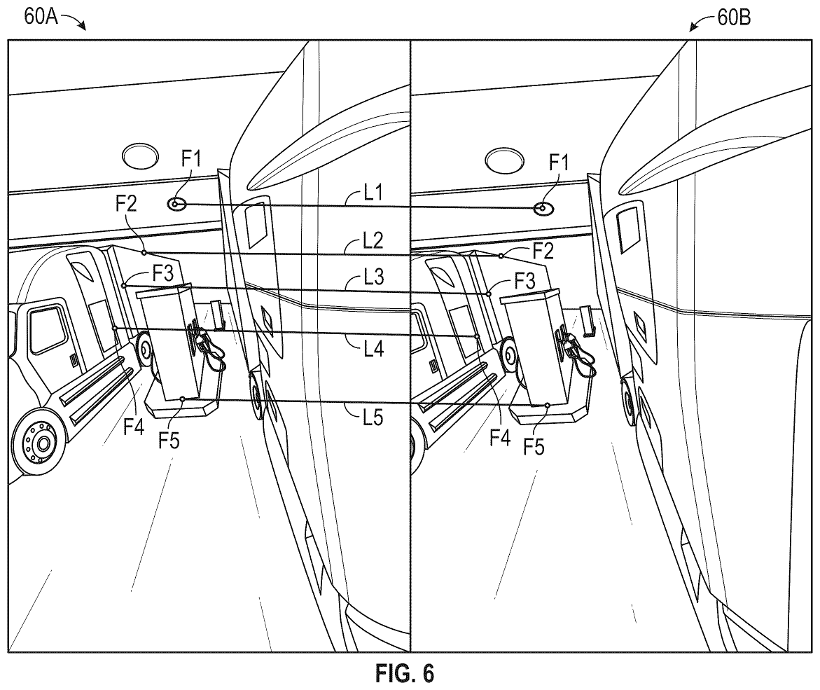

FIG. 6 depicts two example CMS images 60A-B and example features F1-F5 identified through one or more image processing techniques (e.g., a Speeded-Up Robust Features (SURF) algorithm or a Scale-Invariant Feature Transform (SIFT) algorithm). Image 60A is closer to the extended position of FIG. 5A than the image 60B, and image 60B is closer to the retracted position of FIG. 5B than the image 60A. Thus, example images of FIG. 6 are taken at intermediate positions between the retracted position of FIG. 5B and extended position of FIG. 5A.

Assume for the discussion below that the images 60A-B are recorded by camera 20B as the wing 16B is retracting, and that image 60A is recorded before image 60B. Each of the features F1-F5 move between the images 60A-B from a first location in image 60A to a second location in image 60B. Lines L1-L5 connect the points in each image, and are indicative of how much the features move between the two images 60A-B. As discussed in more detail below, the ECU 22 determines a plurality of these distances for a plurality of images, to determine if the camera wing 16 has reached a target position.

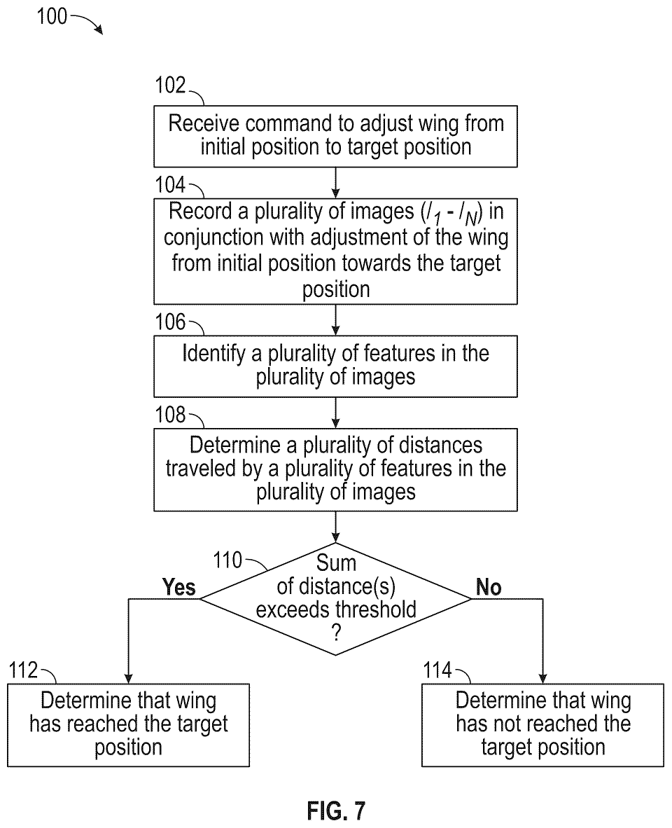

FIG. 7 is a flowchart 100 of an example method for a CMS. The processing circuitry of the ECU 22 is configured to perform at least a portion of the method of the flowchart 100. A command is received to adjust the wing 16 from an initial position to a target position (step 102). As discussed above, the wing 16 is mounted to the commercial vehicle 10, and supports a camera 20. The command of step 102 may be received from a vehicle occupant, or may be part of a software startup routine of the ECU 22 received in connection with startup or shutdown of the commercial vehicle 10, to retract the wing 16 (e.g., in conjunction with shutdown of the commercial vehicle 10) and/or to extend the wing 16 (e.g., in connection with startup of the commercial vehicle 10).

In one example, the initial position is the extended position of FIG. 5A, and the target position is the retracted position of FIG. 5B. In another example, the initial position is the retracted position of FIG. 5B, and the target position is the extended position of FIG. 5A. Of course, other initial and/or target positions could be possible (e.g., partially expanded, partially retracted, etc.).

A plurality of images (I₁-I_{N}) are recorded in conjunction with adjustment of the wing 16 from the initial position towards the target position (step 104). This includes images recorded as the wing 16 is rotating from the initial position towards the target position. In one or more embodiments, image I₁ is recorded when the wing 16 is in the initial position and before the wing 16 has started rotating, and the image I_{N} is recorded after the wing 16 stops rotating, and is expected to be in the target position (e.g., with images I₂-I_{N-1} being recorded therebetween while the wing 16 is rotating).

The ECU 22 identifies a plurality of features in the plurality of images (step 106), and the ECU 22 determines a plurality of distances traveled by the plurality of features in the plurality of images (step 108).

The ECU 22 determines whether a sum of the distances exceeds a predefined threshold T₁ (step 110). If the sum exceeds the threshold T₁ (a “yes” to step 110), the ECU 22 determines that the wing 16 has reached the target position (step 112), and optionally the ECU 22 provides a notification to a vehicle occupant that the wing 16 has successfully reached its target position (e.g., an audible notification, or a visual notification provided through one of the displays 18).

However, if the sum does not exceed the threshold T₁ (a “no” to step 110), the ECU 22 determines that the wing 16 has not reached the target position (step 114), and that there is likely some obstruction that is preventing the wing 16 from reaching the target position or that a motor that drives rotation of the wing 16 is experiencing a fault condition. Optionally the ECU 22 provides a notification to a vehicle occupant that the wing 16 has not successfully reached its target position.

In one or more embodiments, the determination of step 110 is further based on the sum of the distances being within a predefined range which has the predefined threshold T₁ as low end (i.e., lower bound) of the range, and has an additional predefined threshold T2 (which is greater than T₁) as a high end (i.e., upper bound) of the range. Including an upper end of a range as part of the determination could help detect instances where the camera wing 16 travels beyond the target position (e.g., extends beyond the extended position of FIG. 5A).

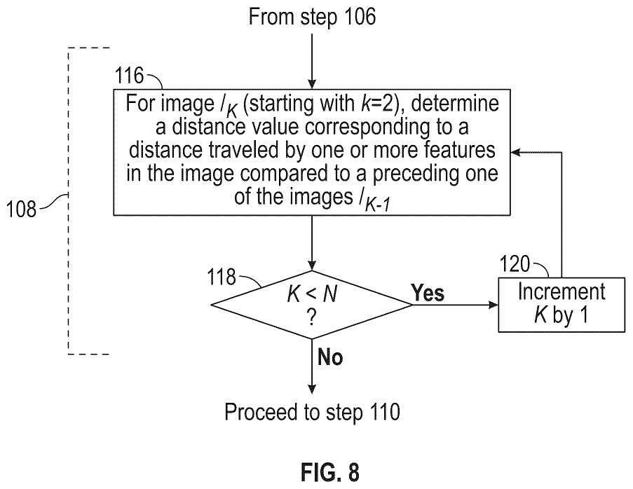

FIG. 8 is an example implementation of step 108 of FIG. 7. For an image IK (and starting with the second image of the plurality images where K=2), the ECU 22 determines a distance value corresponding to a distance traveled by one or more features in the image compared to a preceding I_{K-1} of the plurality of images. In one or more embodiments, a plurality of distances are determined for each pair of images (i.e., images I_{K} and I_{K-1}), and those plurality of distances are averaged to obtain the distance value in step 116. For example, the plurality of distances for images 60A-B could correspond to an average of the distance traveled by each feature F1-F5 between images 60A-B.

If K<N, (a “yes” to step 118), then K is incremented by 1, and step 116 is repeated. Once K<N is no longer true (a “no” to step 118), then, the final image I_{N} has been analyzed, and the method proceeds to step 110.

Stated another way, in the implementation of step 108 shown in FIG. 8, determining the plurality of distances includes, for each of the plurality of images (I₂-I_{N}) other than a first one of the plurality of images (image I₁), detecting one or more of the plurality of features F in the image (I_{K}) and the preceding image (I_{K-1}), and determining a distance value corresponding to a distance traveled by the one or more features F between the image and preceding one of the plurality of images, where the sum of step 110 is a sum of the distance values.

Although only five features F1-F5 are shown in FIG. 6, it is understood that any number of features could be used (e.g., 100+features) to determine the average distance for a particular image.

In one or more embodiments, N is greater than 2 (e.g., between 3-30, between 4-20, or between 5-10). In one or more further embodiments, N=2.

In one or more embodiments, (e.g., with N=2 or with N>2), if one or more features are present in all of the images recorded in step 104, then the same features are tracked across all the images. In one particular example, the determination of whether the wing has reached the target position is based on movement of a single feature across only two images (i.e., N=2).

As the camera wing 16 rotates from its initial position to a target position, it is unlikely that any single feature will be visible in all of the images recorded. The method 100 is not affected by this potential limitation, because many different features could be used, even if only for a subset of the plurality of images.

The method 100 provides an efficient way of determining whether a wing has reached its target position, and avoids the need to for additional dedicated hardware (e.g., position sensors) to make such detections.

Although example embodiments have been disclosed, a worker of ordinary skill in this art would recognize that certain modifications would come within the scope of the claims. For that reason, the following claims should be studied to determine their true scope and content.

What is claimed is:

1. A method for a camera monitor system (CMS), comprising:
determining whether a wing has reached a target position, wherein the wing is mounted to a vehicle, supports a camera, and is rotatable between an initial position and the target position;
wherein the determining is based on a plurality of images recorded by the camera in conjunction with the wing rotating from the initial position towards the target position.

2. The method of claim 1, wherein:
the initial position is a retracted position;
the target position is an extended position; and
the camera is disposed closer to a cabin of a commercial vehicle in the retracted position than in the extended position.

3. The method of claim 1, wherein:
the initial position is an extended position;
the target position is a retracted position; and
the camera is disposed closer to a cabin of a commercial vehicle in the retracted position than in the extended position.

4. The method of claim 1, wherein said determining comprises:
determining a plurality of distances traveled by a plurality of features in the plurality images;
comparing a sum of the distances to a predefined threshold; and
determining that the wing has reached the target position based on the sum of the distances exceeding a predefined threshold.

5. The method of claim 4, wherein said determining that the wing has reached the target position is further based on the sum of the distances being within a predefined range which has the predefined threshold as a low end of the predefined range.

6. The method of claim 4:
wherein said determining a plurality of distances comprises, for each of the plurality of images other than a first one of the plurality of images:
detecting one of the plurality of features in the image and in a preceding one of the plurality of images; and
determining a distance value corresponding to a distance traveled by the feature between the image and preceding one of the plurality of images, wherein the sum of the distances is a sum of the distance values.

7. The method of claim 6, wherein:
said detecting one of the plurality of features in the image and in the preceding image of the plurality of images comprises detecting multiple ones of the plurality of features in the image and the preceding one of the plurality of images; and
said determining a distance value comprises determining an average distance traveled by each of the multiple ones of the plurality of features between the image and the preceding one of the plurality of images.

8. The method of claim 6, comprising:
utilizing a Speeded-Up Robust Features (SURF) algorithm or a Scale-Invariant Feature Transform (SIFT) algorithm to identify the plurality of features.

9. A camera monitor system (CMS), comprising:
a camera;
a camera wing that supports the camera and is rotatable between an initial position and a target position; and
processing circuitry operatively connected to memory and configured to determine, based on a plurality of images recorded by the camera in conjunction with the wing rotating from the initial position towards the target position, whether the wing has reached the target position.

10. The CMS of claim 9, wherein:
the initial position is a retracted position;
the target position is an extended position; and
the camera is disposed closer to a cabin of a commercial vehicle in the retracted position than in the extended position.

11. The CMS of claim 9, wherein:
the initial position is an extended position;
the target position is a retracted position; and
the camera is disposed closer to a cabin of a commercial vehicle in the retracted position than in the extended position.

12. The CMS of claim 9, wherein the processing circuitry is configured to:
determine a plurality of distances traveled by a plurality of features in the plurality images;
compare a sum of the distances to a predefined threshold; and
determine that the wing has reached the target position based on the sum of the distances exceeding a predefined threshold.

13. The CMS of claim 12, wherein the processing circuitry is configured to determine that the wing has reached the target position further based on the sum of the distances being within a predefined range which has the predefined threshold as a low end of the predefined range.

14. The CMS of claim 12:
wherein to determine the plurality of distances, the processing circuitry is configured to, for each of the plurality of images other than a first one of the plurality of images:
detect one of the plurality of features in the image and in a preceding one of the plurality of images; and
determine a distance value corresponding to a distance traveled by the feature between the image and preceding one of the plurality of images, wherein the sum of the distances is a sum of the distance values.

15. The CMS of claim 14, wherein the processing circuitry is configured to, for each of the plurality of images other than a first one of the plurality of images:
detect multiple ones of the plurality of features in the image and the preceding one of the plurality of images; and
determine the distance value as an average distance traveled by each of the multiple ones of the plurality of features between the image and the preceding one of the plurality of images.

16. The CMS of claim 14, wherein the processing circuitry is configured to utilize a Speeded-Up Robust Features (SURF) algorithm or a Scale-Invariant Feature Transform (SIFT) algorithm to identify the plurality of features.

17. A method for a camera monitor system (CMS), comprising:
recording a plurality of images from a camera supported by a wing as the wing rotates from an initial position towards a target position;
determining a plurality of distances traveled by a plurality of features in the plurality images;
comparing a sum of the distances to a predefined threshold; and
determining that the wing has reached the target position based on the sum of the distances exceeding a predefined threshold.

18. The method of claim 17, wherein said determining that the wing has reached the target position is further based on the sum of the distances being within a predefined range which has the predefined threshold as a low end of the predefined range.

19. The method of claim 17, wherein:
the initial position is a retracted position;
the target position is an extended position; and
the camera is disposed closer to a cabin of a commercial vehicle in the retracted position than in the extended position.

20. The method of claim 17, wherein:
the initial position is an extended position;
the target position is a retracted position; and
the camera is disposed closer to a cabin of a commercial vehicle in the retracted position than in the extended position.
